(19) United States
(12) Patent Application Publication
(10) Pub. No.: US 2019/0315066 A1
(43) Pub. Date: Oct. 17, 2019

(54) INFORMATION PROCESSING DEVICE, MODELING DEVICE, MODELING SYSTEM, METHOD AND COMPUTER-READABLE RECORDING MEDIUM

(71) Applicant: Hiroshi MAEDA, Kanagawa (JP)

(72) Inventor: Hiroshi MAEDA, Kanagawa (JP)

(73) Assignee: Ricoh Company, Ltd., Tokyo (JP)

(21) Appl. No.: 16/418,196

(22) Filed: May 21, 2019

Related U.S. Application Data
(63) Continuation of application No. PCT/JP2017/041724, filed on Nov. 20, 2017.

(30) Foreign Application Priority Data
Dec. 2, 2016 (JP) 2016-235385

(51) Int. Cl. B29C 64/393; B33Y 50/02; G05B 19/4099

(52) U.S. Cl. CPC B29C 64/393; G05B 2219/49023; G05B 19/4099; B33Y 50/02

(57) ABSTRACT

An information processing device includes a read unit, a storage unit, and a correction unit. The read unit is configured to read instruction information that causes a modeling device to execute a modeling procedure about a first modeling material body. The storage unit is configured to store modeling material body information about a second modeling material body and modeling material body information about the first modeling material body. The correction unit is configured to correct a first parameter value about the first modeling material body, which is a first parameter value contained in the instruction information read by the read unit, according to the modeling material body information about the second modeling material body and the modeling material body information about the first modeling material body stored in the storage unit.

### CROSS-REFERENCE TO RELATED APPLICATIONS

The present application is a continuation application of International Application No. PCT/JP2017/041724, filed Nov. 20, 2017, which claims priority to Japanese Patent Application No. 2016-235385, filed Dec. 2, 2016. The contents of these applications are incorporated herein by reference in their entirety.

### BACKGROUND OF THE INVENTION

### 1. Field of the Invention

The present invention relates to an information processing device, a modeling device, a modeling system, a method and a computer-readable recording medium.

### 2. Description of the Related Art

The advent of modeling devices (referred to as AM (Additive Manufacturing) devices or 3D printers) has enabled low-cost and quick-turnaround-time manufacturing of samples and parts in a small lot. When modeling is performed with a modeling device, in general, data of a three-dimensional stereoscopic model is loaded into a CAM (Computer Aided Manufacturing) in advance and data for modeling (modeling data) understandable by the modeling device is generated. For example, modeling is performed by fused decomposition modeling (FDM), data of a three-dimensional stereoscopic model sliced into layers is generated and, from the data, modeling data representing a modeling procedure (a working procedure) per layer is generated. The modeling procedure per layer contains instruction information, represented by G codes, instructing the modeling device about, for example, in which route a modeling head is to be moved, which amount of a modeling material (such as resin) is to be pushed out from a nozzle of the modeling head, and at which Celsius degree the modeling material is pushed out.

For stereoscopic modeling in which layers of a three-dimensional object are deposited one by one, there is a disclosed method for improvement on variation in thickness of a material and size precision (see, for example, Japanese Laid-open Patent Publication No. 2016-132214).

Modeling materials have different characteristics in, for example, the fusion temperatures and viscosity, depending on the types of the materials. When a modeling apparatus models the same three-dimensional stereoscopic model by changing only the modeling material, it is necessary to change the instruction information (mainly, parameter values) according to the characteristics of the modeling material after the change. In other words, with respect to a single three-dimensional stereoscopic model, to model three-dimensional stereoscopic models for which the modeling material is changed, it is necessary to newly generate sets of modeling data corresponding to the number of times the modeling material is changed. Generating modeling data requires time and user's work and thus there is a problem in that generating modeling data corresponding to the modeling materials increases the workload.

### SUMMARY OF THE INVENTION

According to one aspect of the present invention, An information processing device includes a read unit, a storage unit, and a correction unit. The read unit is configured to read instruction information that causes a modeling device to execute a modeling procedure about a first modeling material body. The storage unit is configured to store modeling material body information about a second modeling material body and modeling material body information about the first modeling material body. The correction unit is configured to correct a first parameter value about the first modeling material body, which is a first parameter value contained in the instruction information read by the read unit, according to the modeling material body information about the second modeling material body and the modeling material body information about the first modeling material body stored in the storage unit.

### BRIEF DESCRIPTION OF THE DRAWINGS

FIG. 1 is a diagram illustrating an exemplary system configuration of a modeling system according to an embodiment;

FIG. 2 is a diagram illustrating an exemplary hardware configuration of an information processing device;

FIG. 3 is a diagram illustrating an exemplary hardware configuration of a modeling device;

FIG. 4 is a diagram illustrating an exemplary hardware configuration of a control unit;

FIG. 5 is a diagram illustrating an exemplary data structure of nozzle information;

FIG. 6 is a diagram illustrating an exemplary data structure of a material profile;

FIG. 7 is a diagram illustrating an exemplary main function of the information processing device (a CPU and a RAM);

FIG. 8 is a diagram illustrating an exemplary function of the modeling device (the CPU and the RAM);

FIG. 9 is a diagram illustrating exemplary modeling data that causes the modeling device to operate;

FIG. 10A is an explanatory view of an operation performed by a modeling unit to control the modeling device according to the modeling data;

FIG. 10B is an explanatory view of an operation performed by a modeling unit to control the modeling device according to the modeling data;

FIG. 10C is an explanatory view of an operation performed by a modeling unit to control the modeling device according to the modeling data;

FIG. 11 is a diagram illustrating a cooperative relationship among functional units that process modeling data in the modeling system;

FIG. 12 is a diagram illustrating an exemplary order of processes of a process block of a layer-based correction process and a process block of an inter-layer correction process;

FIG. 13 is a diagram illustrating an exemplary process flow of the process block of the layer-based correction process;

FIG. 14 is a diagram illustrating an exemplary process flow of a calculation process;

FIG. 15 is a diagram illustrating exemplary modeling correction data;

FIG. 16 is a diagram illustrating an exemplary process flow of the process block of the inter-layer correction process;

FIG. 17 is a diagram illustrating an exemplary system configuration of a modeling system according to a second embodiment;

FIG. 18 is a diagram illustrating an exemplary functional configuration of a modeling device; and

FIG. 19 is a diagram illustrating a modification of the order of the process block of the layer-based correction process and the process block of the inter-layer correction process.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment has an object to provide an information processing device, a modeling device, a modeling system, a method and a computer-readable recording medium enabling generation of modeling data that matches another modeling material from a single set of modeling data.

### First Embodiment

FIG. 1 is a diagram illustrating an exemplary system configuration of a “modeling system” according to an embodiment. A modeling system X1 illustrated as an example in FIG. 1 is configured to include an information processing device 1 and a modeling device 2. The information processing device 1 includes a CAM (Computer Aided Manufacturing) processing unit 1-1 and a correction processing unit 1-2 and the modeling device 2 includes a modeling processing unit 20. The “correction processing unit 1-2” corresponds to the “read unit” and the “correction unit”.

The CAM processing unit 1-1 is a unit that performs CAM processing of a conventional method to generate data for modeling (referred to as “modeling data”) that is understandable by the modeling device 2 from data of a three-dimensional model. For example, the CAM processing unit 1-1 slices the three-dimensional model in three-dimensional data from a given direction, generates instruction information representing a procedure to fill each layer obtained by the slicing with a modeling material body (a modeling procedure) by combination of a command and a parameter, and generates modeling data about each layer from the bottom layer to the top layer.

The correction processing unit 1-2 is a unit that performs processing to correct the modeling data generated by the CAM processing unit 1-1 to modeling data corresponding to a different type of modeling material body from that of the modeling material body at the time of generation of the modeling data generated by the CAM processing unit 1-1.

The modeling processing unit 20 is a unit that models a three-dimensional stereoscopic model by using a modeling material body, which is set, according to the modeling data corresponding to the modeling material body. For example, the modeling processing unit 20 executes a command contained in the modeling data and performs scanning with a modeling head while heating the modeling head and pushing out the modeling material body on a layer-to-layer basis from the bottom layer to the top layer. Each layer is sequentially built up and thus a three-dimensional model is modeled.

Hardware Configuration

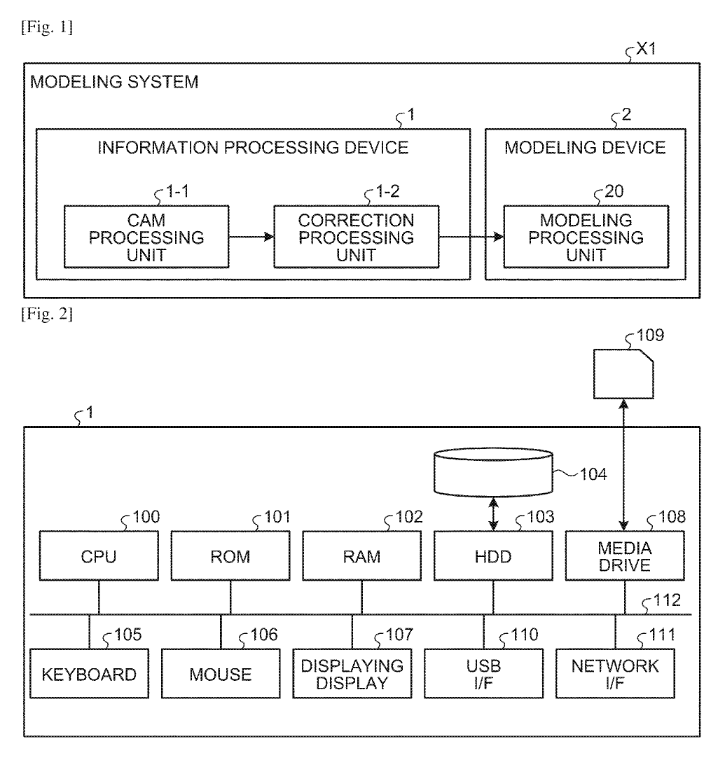

FIG. 2 is a diagram illustrating an exemplary hardware configuration of the information processing device 1. As illustrated in FIG. 2, the information processing device 1 includes a CPU (Central Processing Unit) 100, a ROM (Read Only Memory) 101, a RAM (Random Access Memory) 102, a Hard Disk Drive (HDD) 103, a keyboard 105, a mouse 106, a displaying display 107, a media drive 108, a USB I/F 110 and a network I/F 111. The components are connected to one another via a system bus 112.

The CPU 100 controls the entire information processing device 1 overall by executing a program. The ROM 101 stores a BIOS (Basic Input/Output System), etc. The RAM 102 is used as a work area for the CPU 100 to execute the program, etc.

The HDD 103 controls a hard disk 104 and reads and writes various types of programs and data. The HDD 103 and the hard disk 104 are an example of “the storage unit”. The various types of programs include an OS (Operating System) and an application program for performing modeling data output processing. The data includes “nozzle information D1 (see FIG. 5)” that is an example of “the correspondence information” and a “material profile (information) D2 (see FIG. 6)” that is an example of “the modeling material body information”. The functional configuration of the program relating to the modeling data output processing, the data structure of the “nozzle information D1”, and the data structure of the “material profile D2” will be described below.

Each of the keyboard 105 and the mouse 106 receives input operations performed by a user and notifies the CPU 100 of operational signals corresponding to the input operations.

The displaying display 107 is an LCD (Liquid Crystal Display), or the like, and displays display information that is output from the CPU 100.

Electric connection of a recording medium 109 allows the media drive 108 to read or write a program or data from or in the recording medium 109.

The USB I/F 110 is an interface for USB (Universal Serial Interface) communication with a host. The connection is not limited to USB connection. Wireless connection may be used in addition to wired connection.

The network I/F 111 is an interface (such as an Ethernet (trademark) card) for connection to a communication network, such as a LAN (Local Area Network).

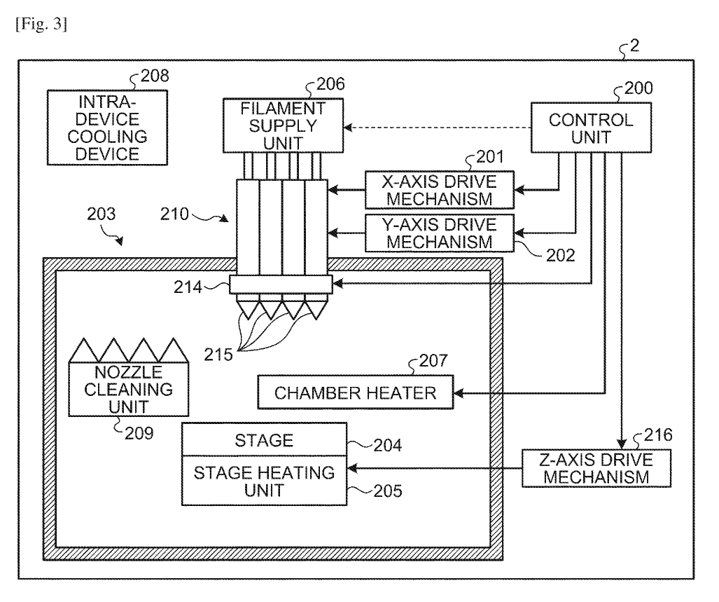

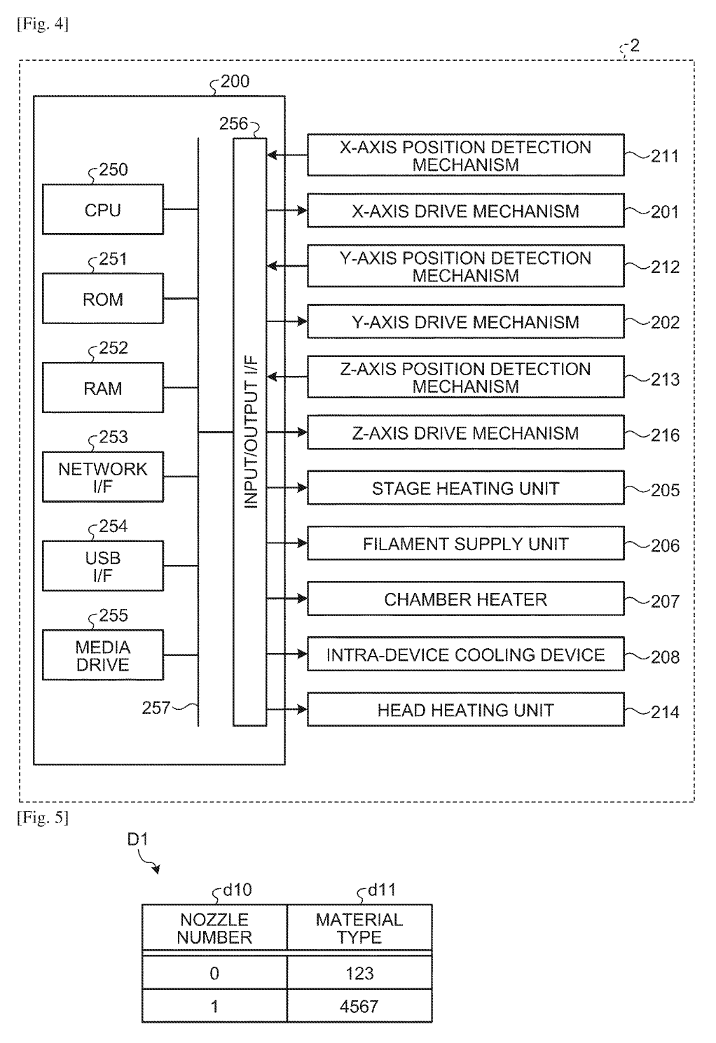

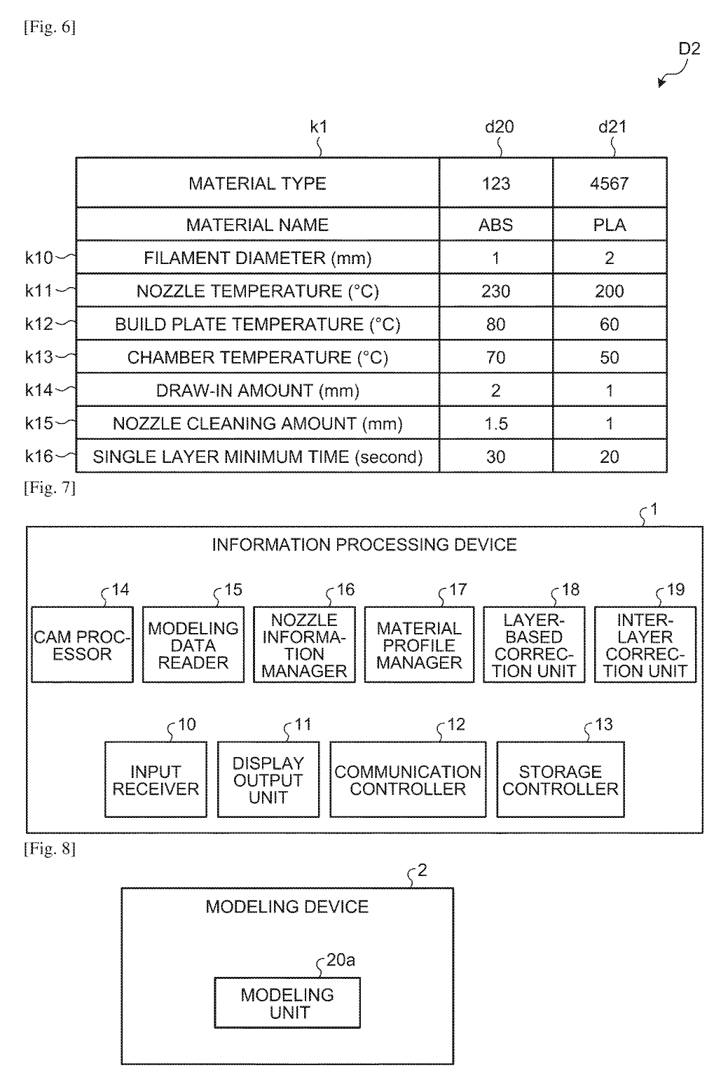

FIG. 3 is a diagram illustrating an exemplary hardware configuration of the modeling device 2. As illustrated in FIG. 3, the modeling device 2 includes a control unit 200, a modeling head 210, a chamber 203 and an intra-device cooling device 208 in the main body frame.

The control unit 200 is responsible for overall control on the modeling device 2.

The modeling head 210 is provided such that the modeling head 210 is movable in an X-axis direction and a Y-axis direction on a horizontal plane by an X-axis drive mechanism 201 and a Y-axis drive mechanism 202, and the modeling head 210 includes a head heating unit 214 and nozzles 215. The head heating unit 214 fuses a filament by heating the modeling head 210. The nozzles 215 are for ejecting filaments and each of the nozzles 215 has an ejection port. The head heating unit 214 and the nozzles 215 are provided in the chamber 203. A filament supply unit 206 supplies filaments to the modeling head 210. A filament is a mode of a modeling material and, for example, is made of a thermoplastic resin and firmed. Ends of wound filaments in the filament supply unit 206 are drawn out and are respectively led to the ejection ports of the nozzles 215 of the modeling head 210.

In the chamber 203, a stage 204, a stage heating unit 205, a chamber heater 207, etc., are provided. The stage 204 is provided such that the stage 204 can be elevated up and down by a Z-axis drive mechanism 216 in the Z-axis direction serving as a direction of layering. Rotation of a pulley (not illustrated) causes a filament to be pushed out from the nozzle 215 onto a build plate (not illustrated) that is arranged on the stage 204, the filament is built up in layers on the build plate, and thus a three-dimensional stereoscopic image is modeled. The stage heating unit 205 is for heating the build plate via the stage 204. The chamber heater 207 is for controlling the internal temperature of the chamber 203. A nozzle cleaning unit 209 is provided in the chamber 203 to clean the nozzles 215. The intra-device cooling device 208 is for cooling the inside of the device. Explanations of the intra-device cooling device 208 and the nozzle cleaning unit 209 end here.

FIG. 4 is a diagram illustrating an exemplary hardware configuration of the control unit 200. As illustrated in FIG. 4, the control unit 200 includes a CPU 250, a ROM 251, a RAM 252, a network I/F 253, a USB I/F 254, a media drive 255, and an input/output I/F 256. The components are connected with one another via a system bus 257.

The CPU 250 controls the entire modeling device 2 overall by executing a program. The ROM 251 stores a fixed program. The RAM 252 is used as a work area for the CPU 250 to execute the program.

The input/output I/F 256 performs inputting and outputting to and from each component of the modeling device 2. Illustration of an X-axis position detection mechanism 211, a Y-axis position detection mechanism 212, and a Z-axis position detection mechanism 213 that are illustrated in FIG. 4 are omitted in FIG. 3.

The network I/F 253 is an interface (such as an Ethernet (trademark) card) for connecting to a communication network, such as a LAN (Local Area Network).

The USB I/F 254 is an interface for USB communication with a host. Connection is not limited to USB connection. Alternatively, wireless connection may be used in addition to wired connection.

Electric connection of the recording medium 109 (see FIG. 3) allows the media drive 255 to read or write a program and data from or in the recording medium 109.

Data Configuration FIG. 5 is a diagram illustrating an exemplary data structure of the nozzle information D1. As illustrated in FIG. 5, in the nozzle information D1, nozzle number information d10 and material type information d11 are associated with each other.

The nozzle number information d10 is an example of “the nozzle identifying information”. The nozzle numbers (0,1, . . . ) of the nozzles 215 of the modeling device 2 are set in the nozzle number information d10.

The material type information d11 is identifying information that identifies the material types of modeling materials (filaments in the embodiment). Unique numbers are added as an example in FIG. 5.

FIG. 6 is a diagram illustrating an exemplary data structure of the material profile D2. Item k1 in the material profile D2 in FIG. 6 is a column representing items of parameter values that are set in the material profile D2, and the data d20 and the data d21 are sets of material profile setting data in which parameter values about the material name “ABS” and the material name “PLA” are set. The material profiles of the two material types that are ABS resin and PLA resin are represented as an example herein; however the types and the number of material types are not limited thereto. For example, the types and the number of the material types may be determined as appropriate, for example, the material may be changed to a material other than resin.

The “filament diameter” represented in item k10 in FIG. 6 is an example of “the outer shape information” and means a diameter of a cross sectional part of the filament. In the example, there is a difference in the diameter of the cross sectional part according to the material types. The “nozzle temperature” represented in item k11 is an example “the temperature to fuse the modeling material body” and is a temperature targeted when the head heating unit 214 heats the modeling head 210. The “build plate temperature” represented in item k12 is a temperature targeted when the stage heating unit 205 heats the stage 204. The “chamber temperature” represented in item k13 is a temperature targeted when the chamber heater 207 heats the inside of the chamber 203. The “drawn-in amount” represented in item k14 is a drawn-in length of the filament to be drawn into the ejection port so as not to cause the fused filament from flowing from the ejection port of the nozzle 215. The “nozzle cleaning amount” represented in item k15 is a length by which the filament is pushed out when the material attached to the ejection port of the nozzle 215 is cleaned. The “single layer minimum time” represented in item k16 is a time required at minimum until the filament pushed out onto the build plate is stabilized (cures) on the build plate.

Functional Configuration

Regarding the CPU 100 and the RAM 102 of the information processing device 1, the CPU 100 reads the program in the ROM 101 or the hard disk 104 to the RAM 102 and the CPU 100 executes the program between the CPU 100 and the RAM 102, thereby implementing various types of functions.

FIG. 7 is a diagram illustrating an exemplary main function of the information processing device 1 (the CPU 100 and the RAM 102). As illustrated in FIG. 7, the information processing device 1 includes common functional units, such as an input receiver 10, a display output unit 11, a communication controller 12, and a storage controller 13.

The input receiver 10 receives input information from the keyboard 105 and the mouse 106. The display output unit 11 outputs display information to the displaying display 107. The communication controller 12 establishes communication with the media drive 108, the USB I/F 110 or the network I/F 111 and transmits and receives data to and from a communication partner. The storage controller 13 reads data from a specified storage area and writes data in a specified storage area.

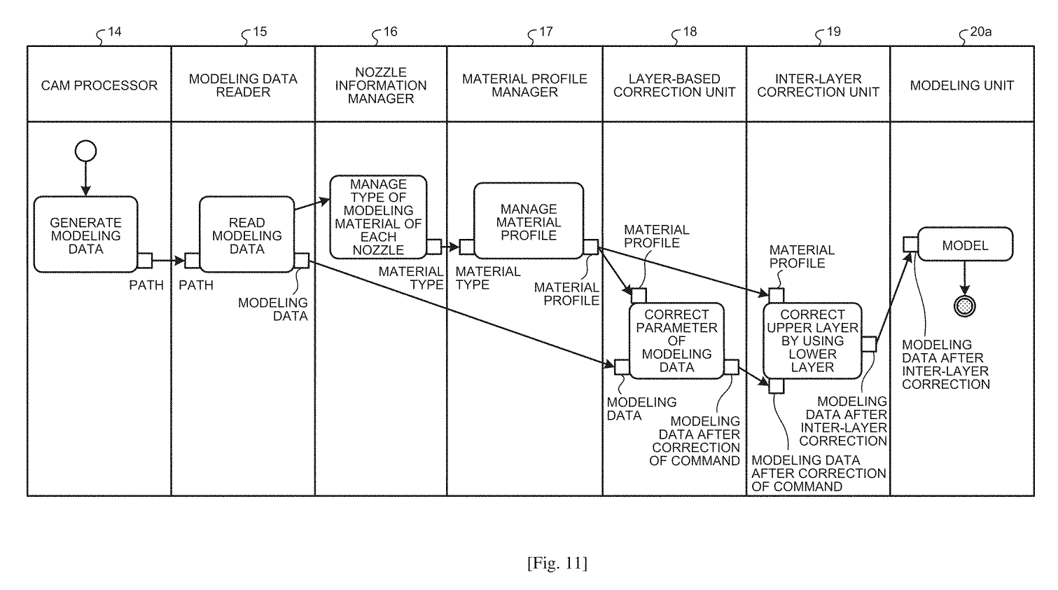

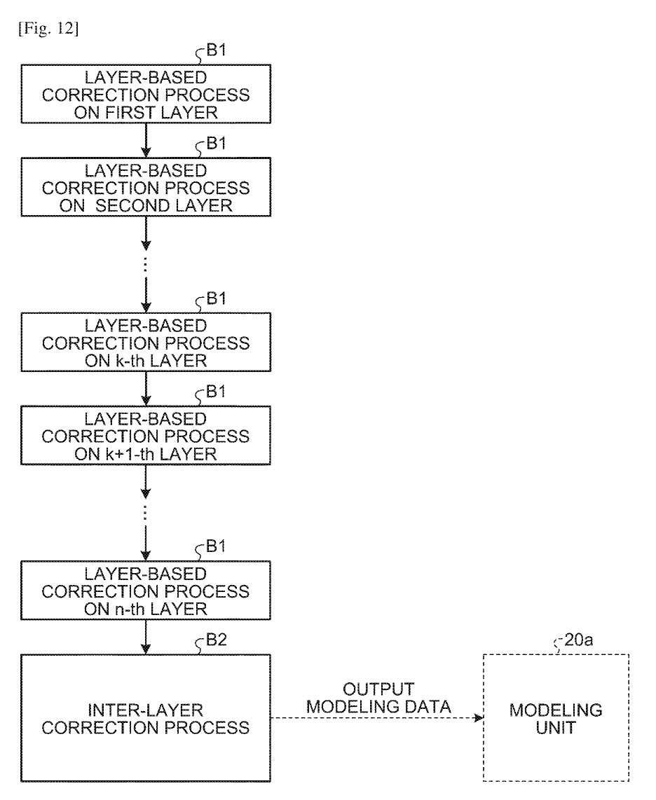

Furthermore, the information processing device 1 includes, as a functional unit that performs the modeling data output processing (hereinafter, a modeling data output processor), a CAM processor 14, a modeling data reader 15, a nozzle information manager 16 (an example of “the read unit”), a material profile manager 17 (an example of “the read unit”), a layer-based correction unit 18, and an inter-layer correction unit 19 (an example of “the inter-layer correction unit”). Each of the components inputs and outputs information to and from various types of hardware, for example, via the above-described common functional units and the components cooperate with one another to perform the modeling data output processing. Each component of the modeling data output processor will be described in FIG. 11. In order to prevent descriptions of each component from being complicated in FIG. 11 and the followings, descriptions of the processing of input and output to and from the common functional units and the various types of hardware that is performed by the modeling data output processor will be omitted.

As for the CPU 250 and the RAM 252 of the modeling device 2, the CPU 250 reds the program of the ROM 251 into the RAM 252 and the CPU 250 executes the program with the RAM 252.

FIG. 8 is a diagram illustrating an exemplary function of the modeling device 2 (the CPU 250 and the RAM 252). As illustrated in FIG. 8, the modeling device 2 implements a modeling unit 20a as a functional unit of the modeling processing unit 20 illustrated in FIG. 1. The modeling unit 20a reads modeling data from the network I/F 253, the USB I/F 254 or the media drive 255 and sequentially executes commands contained in the modeling data. Based on the executed commands, the modeling unit 20a controls the modeling device 2 via the input/output I/F 256.

Operations of Modeling Device

FIG. 9 is a diagram illustrating exemplary modeling data that causes the modeling device 2 to operate. The modeling data may be in any form as long as the modeling data expresses a nozzle temperature, a nozzle movement trajectory, a nozzle movement speed, an amount of the filament to be pushed out, etc. Identifying information of material types (material types of “the first modeling material body”) corresponding to the modeling data is contained in the header or the file name of the modeling data. The modeling data P1 illustrated in FIG. 9 is in a form of G-codes. Commands are contained in the respective rows of the modeling data P1 and the commands are processed sequentially from the top. As the definitions of the respective commands are representation of examples, they may be changed as appropriate.

“M109” represented in the first row of the modeling data P1 represents a command about the nozzle temperature. “S200” and “T0” are a parameter and its value (parameter value) and represent a temperature “200 degrees Celsius” and a nozzle number “0”. In other words, “M109 S200 T0” of the first row means that the nozzle temperature of the nozzle number “0” is to be kept at 200 degrees Celsius. “T0” of the second row means that the following commands are to the nozzle whose nozzle number is “0”. Accordingly, in the case of the modeling data P1 illustrated in FIG. 9, reading the first and second rows makes it possible to know that the modeling data P1 indicates a modeling procedure about the nozzle whose nozzle number is “0”.

Furthermore, “G1” is a nozzle movement command. For example, “G1 X10 Y10 F600” in the fourth row means that the nozzle is to be moved at a speed of 600 mm/min to the position (X,Y)=(10,10), where X is a parameter representing an X coordinate, Y is a parameter representing a Y coordinate, and F is a parameter representing a speed. “G1 X20 Y10 E5 F600” in the fifth row means that the filament is to be pushed out by 5 mm while the nozzle is being moved at a speed of 600 mm/min to the position (X,Y)=(20,10), where E is a parameter representing an amount to be pushed out. Furthermore, “G1 E−1” in the sixth row means that the filament is to be drawn in by 1 mm.

FIG. 9 represents only the modeling procedure for part of one layer; however, modeling data is generated for each layer.

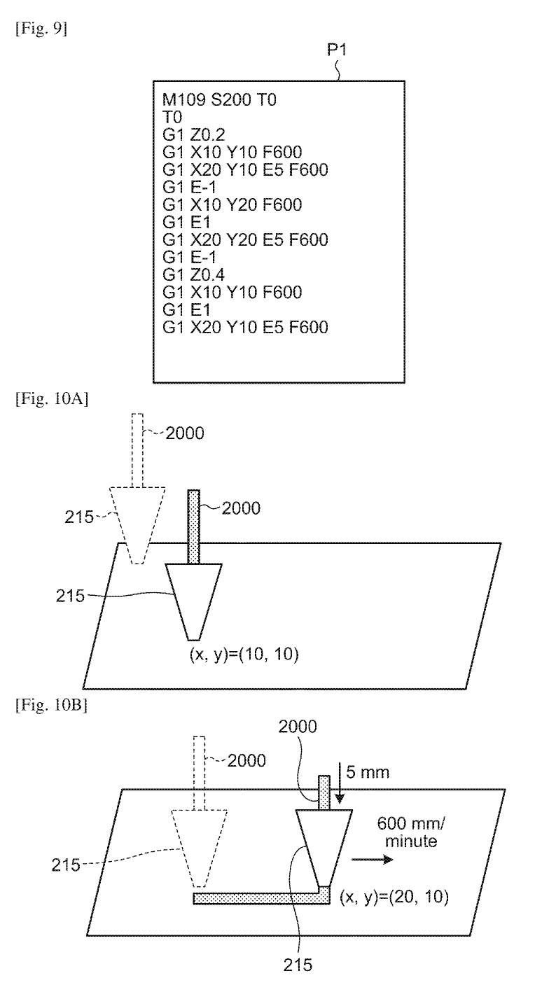

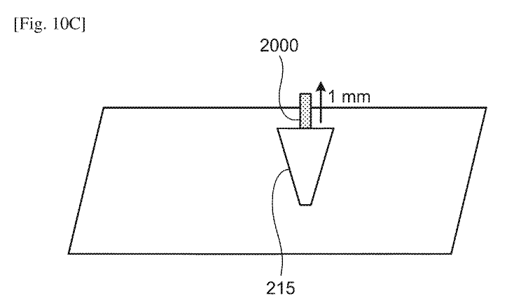

FIGS. 10A, 10B, and 10C are respectively an explanatory view of operations performed when the modeling unit 20a controls the modeling device 2 according to the modeling data P1. FIGS. 10A, 10B, and 10C illustrate operations of the modeling device 2 performed when the modeling unit 20a sequentially executes the commands from the fourth row to the sixth row of the modeling data P1. FIG. 10A illustrates the state where the nozzle moves to the position (X,Y)=(10,10) according to the execution of the command of the fourth row. FIG. 10B illustrates the state where the nozzle pushes out a filament 2000 by 5 mm while moving to the position (X,Y)=(20,10) at a speed of 600 mm/min according to the execution of the command of the fifth row. FIG. 10C illustrates the state where the nozzle draws in the filament 2000 by 1 mm while being kept still in the position (X,Y)=(20,10) according to the execution of the command of the sixth row.

In this manner, the modeling unit 20a executes the commands of the modeling data P1 and controls what to be controlled in the modeling device 2 on the basis of the parameter values.

Operations of Information Processing Device

FIG. 11 is a diagram illustrating a cooperative relationship among the functional units that process modeling data in the modeling system X1. According to FIG. 11, the function of each of the components of the modeling data output processor and cooperation among the components will be described below. Note that, for various types of specifying, such as specifying a path of where data is to be saved and specifying a material type of a filament, the displaying display 107 is caused to display an operation screen to enable the user to specify a path or a material type on the operation screen by operating the keyboard 105, etc.

The CAM processor 14 reads data of a three-dimensional stereoscopic model saved in the specified path (first path) and generates modeling data of a material type, for example, specified by the user from the read data according to a conventional method. The CAM processor 14 saves the modeling data P1 that is generated according to the conventional method (see FIG. 9) in a path (second path) that is specified as where the modeling data is to be saved. When there is an instruction to output the modeling data to the modeling unit 20a of the modeling device 2, the CAM processor 14 outputs the modeling data P1 to the modeling unit 20a of the modeling device 2.

The modeling data reader 15 reads the modeling data P1 that is generated by the CAM processor 14 from the second path. The modeling data reader 15 then reads the identifying information of a nozzle to be controlled (nozzle number in this example) and the identifying information of a material type (first material type) corresponding to the modeling data P1 from the read modeling data P1 and outputs the read sets of identifying information of the nozzle number and the first material type to the nozzle information manager 16. The execution by the modeling data reader 15 is performed when the filament of the modeling device 2 is changed to a filament of another material type or where to which an output is made is changed to a modeling device in which a filament of another material type is set after the generation of the modeling data by the CAM processor 14. When the correspondence relationship between the nozzle number information d10 and the material type information d11 in the nozzle information D1 (see FIG. 5) does not correspond to the modeling device to which an output is made, the modeling data reader 15 is implemented after the user changes the setting in the nozzle information D1 via the setting screen of the information processing device 1 or a setting for the latest correspondence relationship between the nozzle number and the material type is read from the modeling device to which an output is made and the nozzle information D1 is updated.

The nozzle number from the modeling data reader 15 is input to the nozzle information manager 16 and thus the nozzle information manager 16 reads the identifying information of the material type (the second material type) corresponding to the nozzle number from the nozzle information D1 (see FIG. 5) and outputs the identifying information of the first material type and the identifying information of the second material type to the material profile manager 17.

The sets of identifying information of the first and second material types from the nozzle information manager 16 are input to the material profile manager 17 and thus the material profile manager 17 reads the material profile of the first material type (the first material profile) and the material profile of the second material type (the second material profile) and outputs the read material profiles to the layer-based correction unit 18 and the inter-layer correction unit 19.

The material profiles from the material profile manager 17 are input to the layer-based correction unit 18 and thus the layer-based correction unit 18 performs layer-based correction on the modeling data that is read by the modeling data reader 15 according to the material profiles.

The inter-layer correction unit 19 further corrects the modeling correction data, which is obtained by the layer-based correction performed by the layer-based correction unit 18, by using the material profile that is input from the material profile manager 17 and inter-layer conditions (such as a difference in temperature between layers and a minimum time for modeling one layer). The inter-layer correction unit then outputs the modeling data after the inter-layer correction to the modeling unit 20a of the modeling device 2.

Process Flow

FIG. 12 is a diagram illustrating an exemplary order of processes of a process block of the layer-based correction process and a process block of the inter-layer correction process. As illustrated in FIG. 12, in the embodiment, a process block B1 of the layer-based correction process on all the layers (the first layer, the second layer, . . . a k-th layer, a k+l-th layer, . . . , a n-th layer) is finished and then the process block B2 of the inter-layer correction process is performed.

An exemplary flow of the processes of the process block B1 and the process block B2 performed by the modeling data output processor (the modeling data reader 15, the nozzle information manager 16, the material profile manager 17, the layer-based correction unit 18 and the inter-layer correction unit 19) of the information processing device 1 will be described. As the flow of generation of modeling data performed by the CAM processor 14 is a conventional process, illustration in the drawings and descriptions of the generation flow will be omitted.

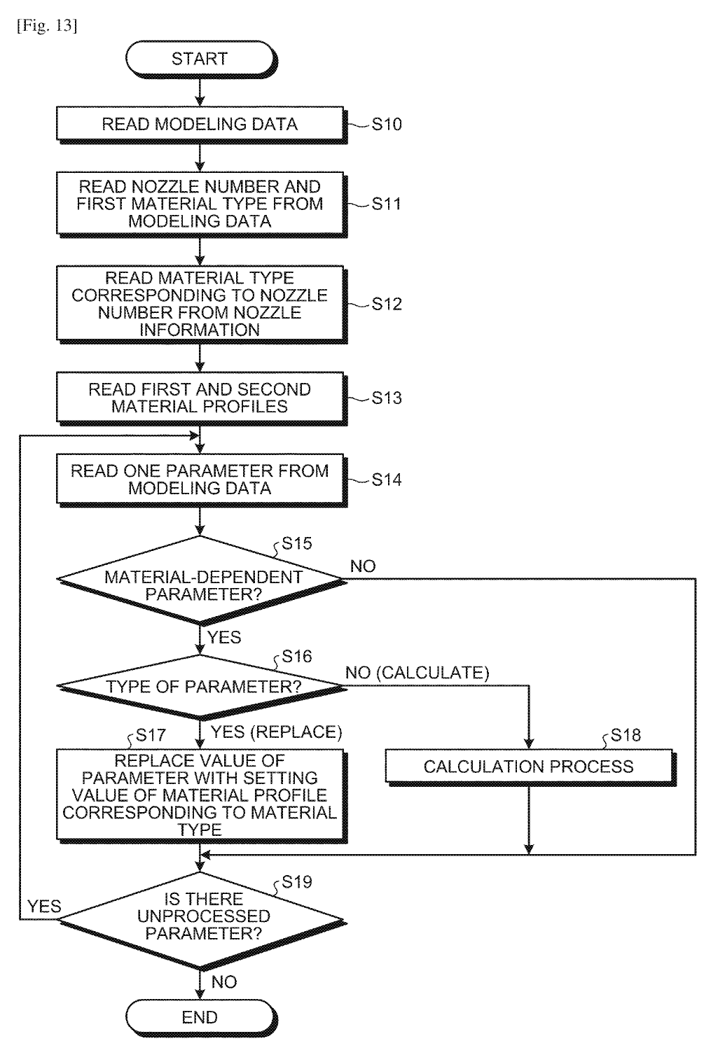

FIG. 13 is a diagram illustrating an exemplary process flow of the process block B1 of the layer-based correction process. The modeling data is not limited to that generated by the CAM processor 14. The modeling data may be one generated by an external CAM device. In this case, the modeling data that is generated by the external CAM device is copied in the specified path (the second path) of the information processing device 1.

First of all, the modeling data reader 15 reads the modeling data from the second path (S10). The modeling data reader 15 reads the identifying information of the nozzle to be controlled (the nozzle number in this example) and the identifying information of the material type corresponding to the modeling data P1 (the first material type) from the read modeling data (the data to be corrected) and outputs the nozzle number and the identifying information of the first material type, which are read, to the nozzle information manager 16 (S11).

The nozzle number from the modeling data reader 15 is input to the nozzle information manager 16 and thus the nozzle information manager 16 thus reads the material type corresponding to the nozzle number (the second material type) from the nozzle information D1 (see FIG. 5) and outputs the identifying information of the first material type and the identifying information of the second material type to the material profile manager 17 (S12).

The sets of identifying information of the first and second material types from the nozzle information manager 16 are input to the material profile manager 17 and thus the material profile manager 17 reads the material profile of the first material type (the first material profile) and the material profile of the second material type (the second material profile) from the material profile D2 (see FIG. 6) and outputs each of the read material profiles to the layer-based correction unit 18 and the inter-layer correction unit 19 (S13).

When the material profiles are input from the material profile manager 17 to the layer-based correction unit 18, the layer-based correction unit 18 reads one parameter from the data to be corrected (S14) and determines whether the parameter is one that depends on the material (S15).

When the parameter is one that depends on the material (YES at step S15), the layer-based correction unit 18 determines whether the parameter value is replaceable from the type of the parameter (S16). For example, when the parameter is a temperature parameter S (see FIG. 9), the layer-based correction unit 18 determines that the parameter value is replaceable. On the other hand, when the parameter is a pushed-out parameter E (see FIG. 9), the layer-based correction unit 18 determines that the parameter value is not replaceable. In the latter case, the layer-based correction unit 18 calculates a parameter value.

When the layer-based correction unit 18 determines that the parameter value is replaceable (YES at step S16), the layer-based correction unit 18 replaces the parameter value with the setting value of the second material profile (step S17).

When the layer-based correction unit 18 determines that the parameter value is not replaceable (NO at step S16), the layer-based correction unit 18 replaces the parameter value with a result of a calculation process to be described below. In the calculation process (step S18), the layer-based correction unit 18 calculates a value with which the parameter value is replaced from the setting value of the first material profile, a setting value of the second material profile, and a parameter value that is set in the parameter. A specific example of the calculation process will be described below.

After the process at step S17 and step S18, the layer-based correction unit 18 determines whether an unprocessed parameter remains in the data to be corrected (step S19). The layer-based correction unit 18 also performs the determination at step S19 when NO determination is made at step S15.

When an unprocessed parameter remains in the data to be corrected (YES at step S19), the process from step S14 is repeated on the remaining parameter.

When no unprocessed parameter remains in the data to be corrected (NO at step S19), the process ends.

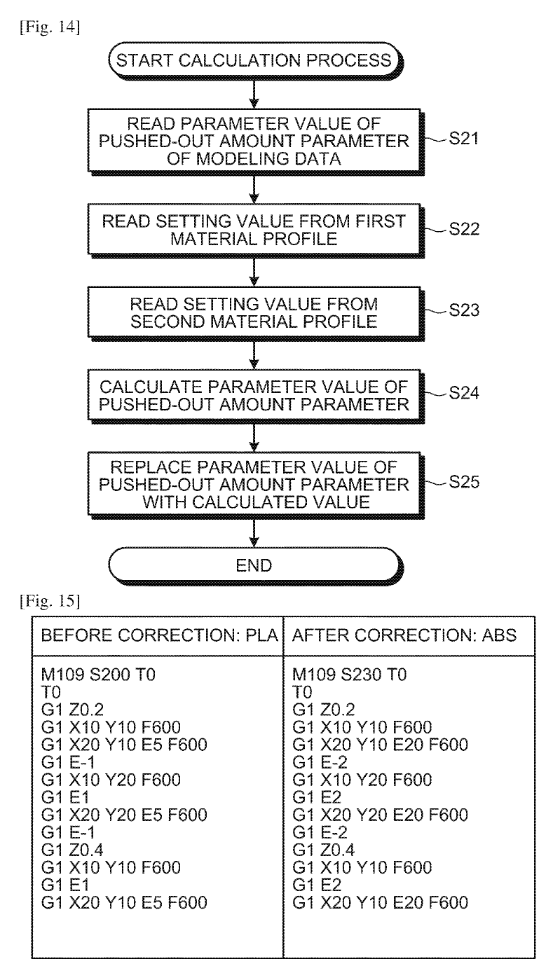

FIG. 14 is a diagram illustrating an exemplary process flow of the calculation process represented at the step S18. A process performed when the layer-based correction unit 18 reads the pushed-out amount parameter E represented in the fifth row of the modeling data P1 (see FIG. 9) at step S14 will be illustrated as an example.

First of all, the layer-based correction unit 18 reads the parameter value of the pushed-out amount parameter E (“5” in this case) that is read at step S14 from the data to be corrected (S21).

The layer-based correction unit 18 then reads the setting value of the filament diameter from the first material profile (S22).

The layer-based correction unit 18 then reads the setting value of the filament diameter from the second material profile (S23).

The layer-based correction unit 18 then calculates a value for replacement from the setting value of the filament diameter of the first material profile (the first setting value), the setting value of the filament diameter of the second material profile (the second setting value), and the parameter value (“5”) of the pushed-out amount parameter E that is read from the data to be corrected (S24).

For example, suppose that the first material profile is the data d21 of the material name “PLA” (see FIG. 6) and the second material profile is the data d20 of the material name “ABS” (see FIG. 6). In this case, the layer-based correction unit 18 reads the filament diameter “2 mm” as the first setting value from the data d21 and reads the filament diameter “1 mm” as the second setting value from the data d20. The parameter value of the pushed-out amount parameter E is a value in the case where the filament diameter is the first setting value (“2 mm”). After the material type of the filament is changed, the filament diameter is small at the second setting value (“1 mm”) and the cross sectional area is reduced to ¼. In order to realize the same pushed-out amount (volume) of the filament, “20” that is four times the parameter value “5” of the pushed-out parameter E is calculated and “20” is used as a value for replacement.

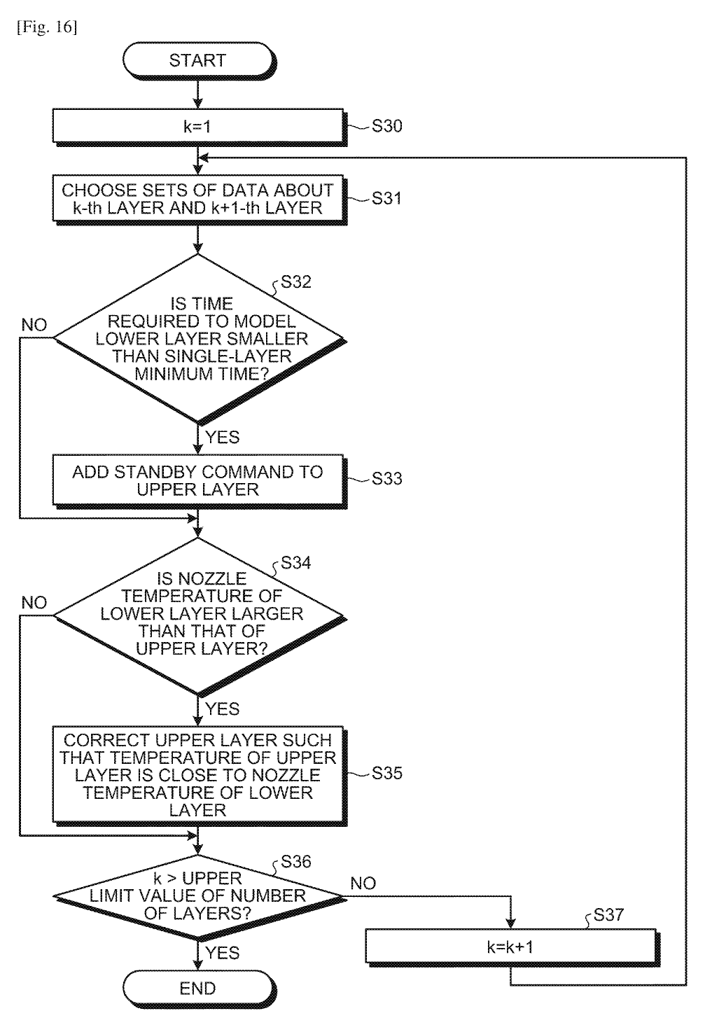

The layer-based correction unit 18 replaces the parameter value with the value for replacement (S25). FIG. 15 is a diagram illustrating exemplary modeling correction data. FIG. 15 illustrates a comparative view between the original modeling data and the corrected modeling data (modeling correction data) in the case where the modeling data about ABS resin is corrected based on the modeling data P1 about the modeling material (filament) that is PLA resin.

As illustrated in FIG. 15, in the molding correction data, for the parameters whose parameter values are replaceable, the setting values for PLA are replaced with the setting values for ABS. For the parameters whose parameter values are not replaceable, replacement with setting values corresponding to ABS is performed by using values for replacement that are calculated by the above-described calculation processing.

FIG. 16 is a diagram illustrating an exemplary process flow of the process block B2 of the inter-layer correction process. First of all, the inter-layer correction unit 19 sets a default value “1” for a variable k (S30).

The inter-layer correction unit 19 chooses sets of modeling correction data about a k-th layer and a k+l-th layer (S31). The k+l-th layer is a layer higher than the k layer by one layer.

The inter-layer correction unit 19 determines whether the time required to model the k layer is smaller than the single layer minimum time (S32). Specifically, the inter-layer correction unit 19 calculates a time required for modeling from the modeling correction data about the k-th layer and determines whether the time is smaller than a setting time that is set for item k16 of the single layer minimum time of the second material profile (see FIG. 6).

When the time required to model the k-th layer is smaller than the single layer minimum time (YES at step S32), the inter-layer correction unit 19 buries a standby command (an example of “the standby information”) for delaying the start of modeling the k+l-th layer by a setting time in the modeling correction data about the k+l-th layer (S33). For a setting time for the standby command, a time enabling the sum of the time required to model the k-th layer and the setting time to be over the single layer minimum time is set.

When the time required to model the k-th layer is equal to or larger than the single layer minimum time (NO at step S32), the inter-layer correction unit 19 skips the process at step S33 and determines whether the parameter value of the nozzle temperature parameter that is set in the modeling correction data about the k-th layer is larger than that of the k+l-th layer (S34).

When the parameter value of the nozzle temperature parameter of the k-th layer is larger than that of the k+l-th layer (YES at S34), the inter-layer correction unit 19 corrects the parameter value of the nozzle temperature parameter of the k+l-th layer such that the parameter value is close to the parameter value of the nozzle temperature parameter of the k-th layer (S35). In other words, the nozzle temperature during the modeling of the k+l-th layer is increased.

When the parameter value of the nozzle temperature parameter of the k-th layer is equal to or smaller than that of the k+l-th layer (NO at step S34), the inter-layer correction unit 19 skips the process at step S35 and determines whether the variable k exceeds the upper limit of the number of layers (S36).

When the variable k does not exceed the upper limit value of the number of layers (NO at step S36), the inter-layer correction unit 19 increments the variable k by one (S37) and performs the processes from step S31. In other words, the inter-layer correction unit 19 performs the inter-layer correction process on the modeling correction data about the layer higher by one layer.

When the variable k exceeds the upper limit value of the number of layers (YES at step S36), the inter layer correction on all the layers has ended and therefore the inter-layer correction unit 19 ends the inter-layer correction process on each layer.

The modeling device 2 may perform part of or all the process of generating modeling data performed by the CAM processing unit 1-1 (see FIG. 1) and the process of correcting modeling data performed by the correction processing unit 1-2 (see FIG. 1).

### Second Embodiment

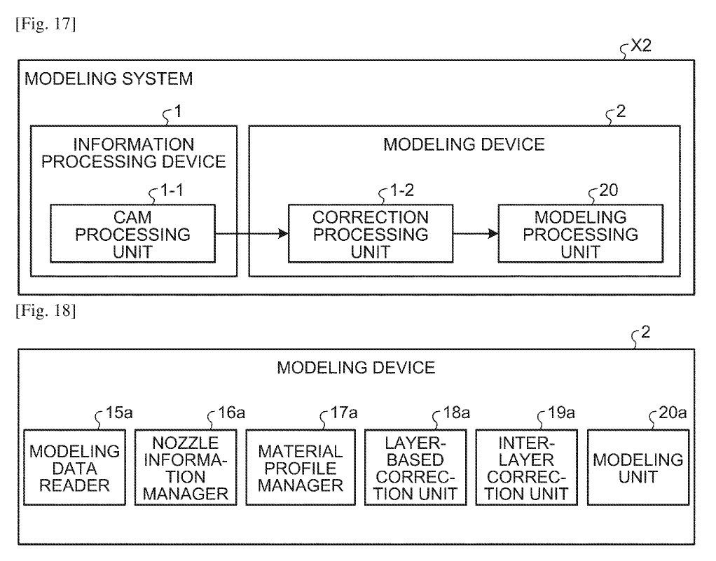

FIG. 17 is a diagram illustrating an exemplary system configuration of a “modeling system” according to a second embodiment. A modeling system X2 illustrated in FIG. 17 is configured to include the information processing device 1 and the modeling device 2 as the modeling system X1 according to the first embodiment illustrated in FIG. 1 is. As for the CAM processing unit 1-1 and the correction processing unit 1-2, the CAM processing unit 1-1 is arranged in the information processing device 1 and the correction processing unit 1-2 is arranged in the modeling device 2.

In the second embodiment, a program and data for performing the modeling data output processing are stored in the ROM 251 of the modeling device 2 (see FIG. 4). The data contains “the nozzle information D1 (see FIG. 5)” and “the material profile (information) D2 (see FIG. 6).

Functional Configuration

FIG. 18 is a diagram illustrating an exemplary functional configuration of the modeling device 2. As illustrated in FIG. 18, the modeling device 2 includes, as a modeling data output processor, a modeling data reader 15a, a nozzle information manager 16a, a material profile manager 17a, a layer-based correction unit 18a, an inter-layer correction unit 19a, and the modeling unit 20a. The components respectively have functions corresponding to the modeling data reader 15, the nozzle information manager 16, the material profile manager 17, the layer-based correction unit 18, the inter-layer correction unit 19, and the modeling unit 20a. Descriptions of cooperative operations among the functional units of the information processing device 1 and the modeling device 2 are redundant and thus the descriptions will be omitted herein.

Process Flow

The first embodiment represents the example where the process block B1 of the layer-based correction process (see FIG. 12) is performed on all the layers and then the process block B2 of the inter-layer correction process (see FIG. 12) is performed. In the second embodiment, the modeling device 2 is able to modify the order of the process block B1 of the layer-based correction process and the process block B2 of the inter-layer correction process.

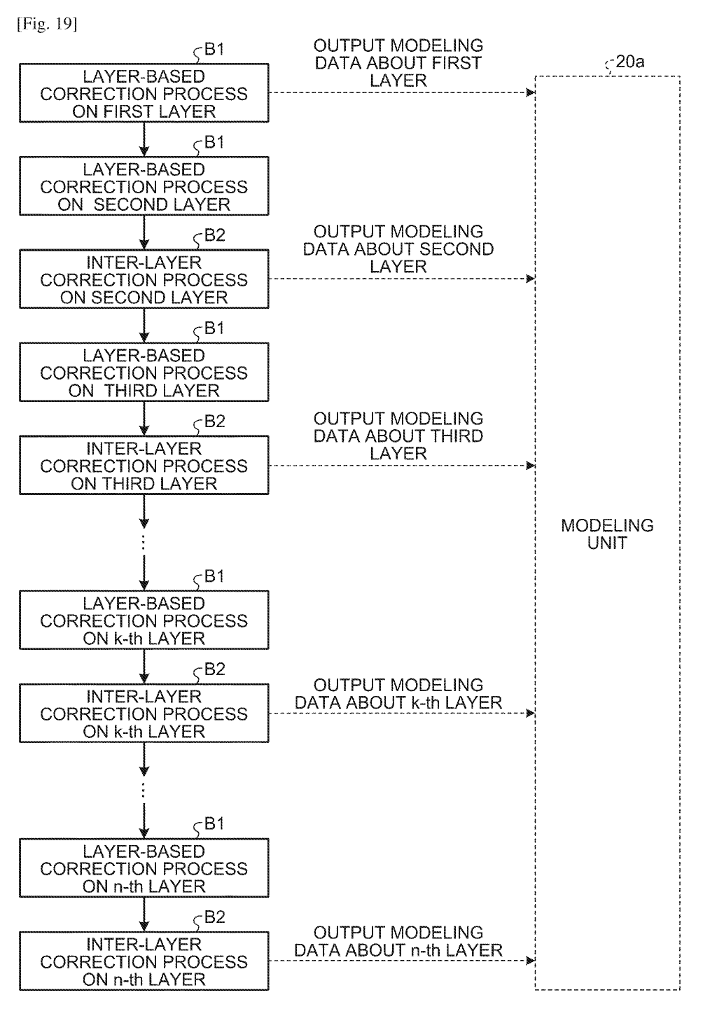

FIG. 19 is a diagram illustrating a modification of the order of the process block B1 of the layer-based correction process and the process block B2 of the inter-layer correction process. As illustrated in FIG. 19, first of all, the layer-based correction process on the first layer (the bottom layer) is performed and then modeling data about the first layer after the layer-based correction process is output to the modeling unit 20a.

The layer-based correction process on the second layer (the layer above the first layer) is performed and subsequently the inter-layer correction process on the second layer is performed by using the modeling data after the layer-based correction process on the first layer. Modeling data about the second layer after the inter-layer correction process is output to the modeling unit 20a. Thereafter, similarly, the layer-based correction process on a k-th layer is performed and subsequently the inter-layer correction process on the k-th layer is performed by using the modeling data after the layer-based correction process on a k−1-th layer. The modeling data about the k-th layer after the inter-layer correction process is output to the modeling unit 20a. The layer-based correction process on a n-th layer (the top layer) is performed and subsequently the inter-layer correction process on the n-th layer is performed by using modeling data after the layer-based correction process on a n−1-th layer. The modeling data about the n-th layer after the inter-layer correction process is output to the modeling unit 20a.

As described above, the modeling device 2 is able to appropriately modify the order of the process block B1 of the layer-based correction process and the process block B2 of the inter-layer correction process. Because of this modification, the modeling unit 20a need not buffer the modeling data about all the layers and thus it is possible to correct molding data even when the memory area is small. Furthermore, the inter-layer correction process is performed on a layer-to-layer basis and this realizes an effect that it is possible to output modeling data sequentially to the modeling unit 20a and thus to start modeling promptly.

Each of the embodiments represents an example of application of the fused decomposition modeling to a modeling device; however, the embodiments are not limited to this method. For example, an optical modeling method, a selective laser sintering and an inkjet method may be used.

The modeling material body is not limited to modeling materials and a supporting member may be used.

As described above, in each of the embodiments, it is possible to generate modeling data matching another modeling material from a single set of modeling data.

The program that is executed by the information processing device according to each of the embodiments is recorded in a computer-readable recording medium, such as a CD-ROM, a flexible disk (FD), a CD-R, or a digital versatile disk (DVD), in a file in an installable form or an executable form and is provided.

The program that is executed by the information processing device according to each of the embodiments may be configured to be stored in computer that is connected to a network, such as the Internet, and downloaded via the network to be provided. Furthermore, the program that is executed by the information processing device according to each of the embodiments may be configured to be provided or distributed via a network, such as the Internet.

The program of each of the embodiments may be configured to be incorporated in a ROM, or the like, in advance and provided.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein. Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc. Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

An embodiment realizes an effect of enabling generation of modeling data matching another modeling material from a single set of modeling data.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

### REFERENCE SIGNS LIST

1 Information processing device
1-1 CAM processing unit
1-2 Correction processing unit
2 Modeling device
20 Modeling processing unit
X1 Modeling system

1. An information processing device comprising:
a read unit configured to read instruction information that causes a modeling device to execute a modeling procedure about a first modeling material body;
a storage unit configured to store modeling material body information about a second modeling material body and modeling material body information about the first modeling material body; and
a correction unit configured to correct a first parameter value about the first modeling material body, which is a first parameter value contained in the instruction information read by the read unit, according to the modeling material body information about the second modeling material body and the modeling material body information about the first modeling material body stored in the storage unit.

2. (canceled)

3. The information processing device according to claim 1, wherein
the modeling material bodies are filaments;
the modeling material body information about the first modeling material body includes first outer shape information representing outer shape information about the first modeling material body,
the modeling material body information about the second modeling material body includes second outer shape information representing outer shape information about the second modeling material body, and
the correction unit corrects an amount of the first modeling material body to be ejected, which is an amount serving as the first parameter value contained in the instruction information read by the read unit, by using a value that is calculated according to the amount and the first outer shape information and the second outer shape information that are stored in the storage unit.

4. The information processing device according to claim 1, wherein
the storage unit stores
correspondence information indicating a correspondence relationship between identifying information of nozzles that eject modeling material bodies and identifying information of the modeling material bodies and
modeling material body information about a modeling material body contained in the correspondence information, which is modeling material body information serving as the modeling material information about the second material body, and
the correction unit corrects the first parameter value contained in the instruction information about the first modeling material body according to the modeling material information corresponding to the identifying information of the modeling material body that is associated with the identifying information of the nozzle of the modeling device in the correspondence information.

5. The information processing device according to claim 1, wherein
the modeling material information includes a second parameter value about the second material body corresponding to the first parameter value about the first material body, and
the correction unit corrects the first parameter value contained in the instruction information about the first modeling material body by replacing the first parameter value with the second parameter value stored in the storage unit.

6. The information processing device according to claim 5, wherein
the instruction information includes, as the first parameter value, a temperature that fuses the first modeling material body.

7. The information processing device according to claim 1, further comprising
an inter-layer correction unit configured to correct instruction information about an upper layer according to instruction information about a lower layer in the instruction information.

8. The information processing device according to claim 7, wherein
the inter-layer correction unit incorporates standby information until start of modeling in the instruction information about the upper layer according to a time required to model the lower layer.

9. The information processing device according to claim 7, wherein
the inter-layer correction unit corrects a temperature about a modeling material body of the upper layer according to a temperature about a modeling material body of the lower layer.

10. An modeling device that performs modeling based on the first parameter value corrected by the correction unit of the information processing device according to claim 1.

11. A modeling system comprising the information processing device and the modeling device according to claim 10.

12. A method comprising:
reading instruction information for executing a modeling procedure about a first modeling material body;
reading modeling material body information about a second modeling material body and modeling material body information about the first modeling material body; and
correcting a first parameter value about the first modeling material body contained in the instruction information according to the material body information about the second modeling material body and the modeling material body information about the first modeling material body.

13. A computer-readable recording medium that contains a program that causes a computer of an information processing device including a storage unit that stores modeling material body information about a second modeling material body and modeling material body information about a first modeling material body to function as
a read unit configured to read instruction information for executing a modeling procedure about the first modeling material body;
a read unit configured to read the modeling material body information about the second modeling material body and the modeling material body information about the first modeling material body from the storage unit; and
a correction unit configured to correct a first parameter value about the first modeling material body, which is a first parameter value contained in the instruction information read by the read unit, according to the modeling material body information about the second modeling material body and the modeling material body information about the first modeling material body read by the read unit.
